(19) United States
(12) Patent Application Publication
(10) Pub. No.: US 2013/0288046 A1
(43) Pub. Date: Oct. 31, 2013

(54) Magnesium Alloy with Dense Surface Texture and Surface Treatment Method Thereof

(71) Applicant: Young-Hee Park, Pohang-si (KR)

(72) Inventor: Young-Hee Park, Pohang-si (KR)

(73) Assignee: POSCO, Pohang-shi (KR)

(21) Appl. No.: 13/976,304

(22) PCT Filed: Dec. 28, 2011
(86) PCT No.: PCT/KR11/10240

§ 371 Date: Jun. 26, 2013

(30) Foreign Application Priority Data
Dec. 28, 2010 (KR) 10-2010-0137224

(51) Int. Cl. B05D 1/36; B05D 3/12

(52) U.S. Cl. CPC B05D 1/36; B05D 3/12
USPC 428/336; 427/292; 427/402; 428/450

(57) ABSTRACT

The present invention provides a magnesium alloy with dense surface texture and its surface treatment method, and more particularly to a magnesium alloy and its surface treatment method, where the magnesium alloy includes: a parent material including magnesium or magnesium alloy; a surface-modified layer being formed on the surface of the parent material and containing Si; and a coating layer formed on the surface-modified layer, where the surface-modified layer comprises a “—Si—O—Mg—” structure.

### TECHNICAL FIELD

The present invention relates to a magnesium alloy with dense surface texture and thus improved mechanical strength and a surface treatment method thereof.

### BACKGROUND ART

Magnesium is the eighth most abundant element in the Earth's crust and a low-density metal harmless to the human body, so it has enormous potential to be applicable to the interior/exterior materials for a variety of products. As a metal with relatively high specific strength, magnesium is attracting a lot of interest as a novel material that goes with the trends toward lightweight and power-saving products and substitutes for the existing materials to make up for the weaknesses of the plastic materials. The magnesium alloy has been used the fields of automobile, aerospace applications, laptop computers, mobile information equipment, and so forth, and its applications are on an increasing trend.

The magnesium alloy has excellent characteristics, such as high anti-vibration capability, exceptional absorbent properties on vibration and shock, excellent electromagnetic shielding properties, lightweight characteristics, high specific strength, or the like. Disadvantageously, however, the magnesium alloy exhibits poor formability at room temperature, requiring an elevated temperature of 250° C. or above in the rolling or forming process.

Generally, the magnesium alloy is subjected to a surface treatment process by performing mechanical polishing, paint pre-treatment, and painting. Although the surface treatment process includes all the aforementioned steps, there inevitably forms a surface layer on the surface of the magnesium alloy due to oxidation of magnesium. As illustrated in FIG. 1, for example, the surface layer caused by oxidation of magnesium is formed between the magnesium and the surface-treated layer even in the case that the magnesium alloy has a structure including a sol-gel layer, a primer layer, an intermediate paint layer, and a top paint layer. In this regard, a surface treatment process carried out on the magnesium alloy in the air ends up with forming an oxidized layer approximately 5 nm or so, which layer is composed of magnesium oxide, magnesium hydroxide, and magnesium carbonate. When dipped into water, the surface layer of the magnesium alloy exposed to the air is susceptible to change in thickness to about 20 to 30 nm. During a surface buffing process using water in the production process, the pH of the water used in the process turns to alkaline with the pH value of about 11, in which case the surface layer grows to a thickness of about 50 nm by the buffing process. In other words, the surface layer of the magnesium alloy contains MgO, Mg(OH)₂, and MgCO₃, among which Mg(OH)₂ rather than MgO exists dominantly in the surface layer when the buffing process using water is carried out.

The oxidized layer thus formed causes deterioration of adhesion to the paint layer and discoloration in the salt spray test, adversely leading to unsatisfactory durability and reliability of the products such as laptop computers that use the magnesium alloy as an exterior material.

Thus, to solve this problem, there have been used a variety of surface treatment methods for magnesium alloys, including, for example, performing a mechanical surface polishing (such as gloss polishing, hairline polishing, etc.) widely used to process a metal material and then adopting alkali treatment process for surface cleaning to form a surface-treated layer. In addition, the surface treatment methods for magnesium alloys include anodizing treatment, chemical conversion treatment, plasma electrolytic oxidation, Zn Immersion Coating, electroless Ni plating, etc.

Although the magnesium alloy is known to be stable to alkali, the surface of magnesium is etched on the nanometer scale by alkali, as already described above, and susceptible to change in the thickness of the surface layer. Therefore, the alkali treatment process ends up with the magnesium alloy etched by alkali and thus changed in the thickness of the surface texture. The poor mechanical properties of the surface texture thus formed play a role in causing deteriorated adhesion of the layer after the surface treatment such as sol-gel coating or painting, thereby leading to entire deterioration in the quality of the surface treatment.

The magnesium surface texture, that is, the magnesium hydroxide thin film, has such a low density as to deteriorate the mechanical properties. Consequently, surface appearance defects such as stains on the surface of a magnesium alloy during the surface treatment process, defects in the chemical conversion treatment or plating process, or defects in coating adhesion after the painting process or salt water resistance are mostly attributed to the oxidized layer or the hydroxide layer.

### DISCLOSURE

### Technical Field

It is an object of the present invention to provide a magnesium alloy with dense surface texture and a surface treatment method thereof that prevents surface appearance defects such as stains occurring during the surface treatment process, defects in the chemical conversion treatment or plating process, or defects in coating adhesion after the painting process or salt water resistance and ensures the adhesion stability of the surface-treated layer to enhance mechanical properties.

It is another object of the present invention to provide a magnesium alloy available for the use purpose as an automobile steel sheet or a copper clad laminate for printed circuit board, and a surface treatment method thereof.

### Technical Solution

The present invention provides a magnesium alloy comprising: a parent material including magnesium or magnesium alloy; a surface-modified layer being formed on the surface of the parent material and containing Si; and a coating layer formed on the surface-modified layer, where the surface-modified layer comprises a “—Si—O—Mg—” structure.

The surface-modified layer may comprise a “—Si—O—Mg—O—Si” structure and have a thickness of 50 nm to 150 nm. Further, the surface-modified layer may be formed by treating the surface of the parent material with an aqueous alkaline solution comprising 1 to 5 wt. % of potassium hydroxide or 1 to 10 wt. % of sodium hydroxide, and 1 to 5 wt. % of tetraethyl orthosilicate. The coating layer may comprise a paint layer or a metal layer.

In addition, the present invention provides a surface treatment method for magnesium alloy comprising the steps of: (a) preparing a parent material comprising magnesium or magnesium alloy; (b) treating the parent material with a silicate-containing alkaline solution to form a surface-modified layer on the surface of the parent material; and (c) forming a coating layer on the surface-modified layer, wherein the alkaline solution uses 1 to 5 wt. % of potassium hydroxide or 1 to 10 wt. % of sodium hydroxide, and 1 to 5 wt. % of tetraethyl orthosilicate.

In the present invention, the step (c) of forming a coating layer may include the steps of forming a paint layer or a metal layer. The paint layer may be formed by applying at least one layer of a paint on the surface of the surface-modified layer by coating. The surface treatment method may further comprise the steps of forming a sol-gel coating layer on the surface of the parent material having the surface-modified layer formed on it, before forming the paint layer. The metal layer may be formed by laminating at least one metal selected from the group consisting of copper (Cu), aluminum (Al), silver (Ag), gold (Au), nickel (Ni), platinum (Pt), and tungsten (W) on the surface of the coating layer. In the case that the coating layer is a metal layer, the surface treatment method may further comprise the steps of forming a resin layer between the surface-modified layer and the metal layer of the coating layer.

Hereinafter, the present invention will be described in further detail.

Conventionally, the surface of the magnesium alloy is treated by an electrical current applying method using an electrolyte or a chemical conversion treatment method. The electrical current applying method is still problematic in that it causes deterioration of the mechanical properties. The chemical conversion method also has a problem that chemical conversion hardly works on the magnesium material and necessarily uses an acid for etching and chemical conversion.

Generally, there exists a surface layer of magnesium oxide or magnesium hydroxide that deteriorates adhesion of the surface-treated layer and salt water resistance and causes appearance defects on the surface of the magnesium alloy.

In order to enhance the properties, such as adhesion and salt water resistance, of the parent material including magnesium or magnesium alloy and prevent occurrence of surface appearance defects, the present invention provides a magnesium alloy and its preparation method, introducing a silicate compound into the surface layer of magnesium oxide or magnesium hydroxide on the surface of the parent material to form a dense surface texture on the oxidized or hydroxide coating layer on the surface and enhance the properties.

In other words, the present invention may provide a magnesium alloy member and its processing method, introducing Si into a nanometer-scale oxidized layer or hydroxide layer existing on the surface of the parent material including magnesium or magnesium alloy to change the surface layer into a coating layer having a dense texture and form a surface-modified layer modified to be suitable for the subsequent surface treatment process.

Accordingly, the surface texture of the magnesium alloy into which a silicate compound is introduced has improved mechanical strength and hence adhesion stability to the subsequent coating layer. Particularly, the present invention can secure adhesion and durability of the subsequent surface-treated layer by making the hydroxide coating layer more dense on the surface of the parent material. Although the hydroxide coating layer not surface-treated attributes to the different defects on the surface quality due to its problematic texture, the surface treated according to the present invention has a remarkable improvement of the properties.

The present invention can also secure adhesion stability and durability of the subsequent surface-treated layer by penetrating a silicate compound mixed in an alkali-treated solution into the surface texture of the parent material to make the surface texture more dense. In addition, the magnesium alloy treated by the method of the present invention has such a dense surface texture to maintain excellent coating adhesion without surface appearance defects such as surface stains in the boiling water resistance test after the painting/finishing process and shows no defect possibly occurring even in the chemical conversion or plating process, thereby enhancing product quality when used as an exterior material. The magnesium alloy of the present invention is available for the use purpose as an automobile steel sheet or a metal copper clad laminate (MCCL) for printed circuit board.

More specifically, the surface of the parent material according to the present invention may contain magnesium oxide or magnesium hydroxide, and when the parent material is dipped into the alkaline solution containing tetraethyl orthosilicate, silicate binds to water in the alkaline solution to form a “—Si—O—Si” structure on the surface of the parent material. This structure reacts with the magnesium hydroxide to produce a bonding structure represented by the following chemical formula I, thereby forming a surface-modified layer. In this regard, according to the present invention, “—O—Si-” binds to the magnesium of the chemical formula I to form a network structure of “—Si—O—Mg—O—Si—” in the surface-modified layer. This means the formation of a layer with a dense surface layer.

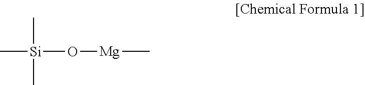

In other words, the present invention, by introducing a silicate compound into the surface of the parent material including magnesium or magnesium alloy, can not only ensure an increase in the thickness of the surface texture by alkaline etching, but also cause the magnesium hydroxide layer with low density to bind to silicate, resulting in a dense surface structure. Therefore, the present invention greatly improves the mechanical strength of the surface layer of the parent material to enhance the adhesion to the subsequent coating layer and the salt water resistance.

Accordingly, a preferred embodiment of the present invention provides a magnesium alloy comprising: a parent material comprising magnesium or magnesium alloy; a surface-modified layer being formed on the surface of the parent material and containing Si; and a coating layer formed on the surface-modified layer, where the surface-modified layer includes a “—Si—O—Mg—” structure. More preferably, the present invention provides a magnesium alloy comprising: a magnesium alloy layer; a surface-modified layer being formed on the surface of the magnesium alloy layer and including a “—Si—O—Mg—” structure; and a coating layer formed on the surface-modified layer. In the present invention, the coating layer includes a paint layer or a metal layer.

FIG. 2 is a schematic diagram showing a cross section of the magnesium alloy with dense surface texture according to one embodiment of the present invention.

Unlike the conventional magnesium alloys, the magnesium alloy of the present invention can change the hydroxide layer naturally formed on the surface of magnesium into a stable surface-modified layer, as illustrated in FIG. 2, by using a predetermined amount of tetralkoxysilane (that is, the silicate compound) in the alkali treatment process for cleaning the surface of the parent material.

Especially, the thickness of the surface layer increases in the alkali treatment process, and Si penetrates into the surface of magnesium and binds to the oxygen in the magnesium oxide or magnesium hydroxide existing in the surface of the parent material including magnesium or magnesium alloy, so the surface-modified layer has the “—Si—O—Mg—” structure. With this structure, the present invention can prevent visual appearance defects possibly formed on the surface of the existing magnesium alloy during the surface treatment process, or the defects occurring in the chemical conversion process or the plating process. Further, as a paint layer is formed on the surface-modified layer, the present invention can prevent defects in the coating adhesion or the salt water resistance after the painting process and ensure adhesion stability of the surface-treated layer to enhance the mechanical properties. Such a surface-modified layer may have a thickness of 50 nm to 150 nm. The surface-modified layer may be formed by treating the surface of the parent material with an aqueous alkaline solution containing 1 to 5 wt. % of potassium hydroxide or 1 to 10 wt. % of sodium hydroxide, and 1 to 5 wt. % of tetraethyl orthosilicate.

In the structure of the surface-modified layer of the magnesium alloy according to the present invention, the coating layer implicitly includes a paint layer or a metal layer.

According to one embodiment of the present invention, the magnesium alloy can be used as a material for automobile steel sheets, when a paint layer is formed as the coating layer on the silicate-containing surface-modified layer.

According to another embodiment of the present invention, the magnesium alloy can be produced as a copper clad laminate and used as a material for printed circuit boards, when a metal layer is formed as a coating layer on the silicate-containing surface-modified layer. In the case where the magnesium alloy is used as a copper clad laminate, it may further include a resin layer for adhesion with the metal layer between the surface-modified layer and the metal layer of the coating layer. In other words, the resin layer is positioned between the surface-modified layer and the metal layer of the coating layer.

The paint layer may include at least one layer, preferably at least two layers formed from a paint. The thickness of the paint layer is not specifically limited, but preferably in the range of 8 μm to 12 μm. The thickness of the paint layer may be substantially 10 μm.

The metal layer may include at least one metal selected from the group consisting of copper (Cu), aluminum (Al), silver (Ag), gold (Au), nickel (Ni), platinum (Pt), and tungsten (W). The metal layer includes copper (Cu) in consideration of electrical characteristics, heat transfer characteristics, and price. Preferably, the metal layer is a copper clad laminate using copper (Cu).

The resin layer uses any resin generally available to the fabrication of metal laminates for typical printed circuit boards. Thus, any known material in the related art can be used for the resin layer without any specifical limitation in its type and thickness.

On the other hand, the parent material including magnesium or magnesium alloy used to achieve surface treatment in the present invention may further include a magnesium oxide layer or a magnesium hydroxide layer on its surface. Further, the parent material including a magnesium alloy may further include different elements, such as aluminum, zinc, etc., and take the form of a molded part or a sheet. Preferably, the surface of the parent material is mechanically polished. For example, the parent material may include a surface-polished magnesium alloy layer, or the magnesium oxide layer or the magnesium hydroxide layer formed on the surface of the magnesium alloy layer is mechanically polished. For another example, the magnesium alloy layer of the present invention may include a “AZ21” magnesium alloy comprising about 2 wt. % of aluminum and about 1 wt. % of zinc; a “AZ31” magnesium alloy comprising about 3 wt. % of aluminum and about 1 wt. % of zinc, a “AZ61” magnesium alloy comprising about 6 wt. % of aluminum and about 1 wt. % of zinc, or an Li-containing magnesium alloy. Thus, the surface-polished magnesium alloy layer includes a magnesium alloy containing aluminum and zinc and being formed on the surface of the magnesium oxide layer or the magnesium hydroxide layer. The surface-polished magnesium alloy layer can be obtained by mechanically polishing the surface of the magnesium alloy.

The thickness of the parent material is not specifically limited and may be given as well known in the related art. Further, the parent material of the present invention, when including the metal layer, may have a thick layer having a micrometer-scale thickness, for example, ranging from 50 μm to 5,000 μm.

In accordance with another exemplary embodiment of the present invention, there is provided a surface treatment method for magnesium alloy comprising the steps of: (a) preparing a parent material including magnesium or magnesium alloy; (b) treating the parent material with a silicate-containing alkaline solution to form a surface-modified layer on the surface of the parent material; and (c) forming a coating layer on the surface-modified layer, wherein the alkaline solution uses 1 to 5 wt. % of potassium hydroxide or 1 to 10 wt. % of sodium hydroxide, and 1 to 5 wt. % of tetraethyl orthosilicate.

In the step (a), the parent material may further include a natural oxidized layer comprising magnesium oxide or magnesium hydroxide on its surface.

Further, the step (c) of forming a coating layer may include the steps of forming a paint layer or a metal layer.

The paint layer may be formed by applying at least one coating layer of a paint, preferably at least two coating layers of a paint on the surface of the surface-modified layer. Further, the surface treatment method may further include the steps of forming a sol-gel coating layer on the surface of the parent material having the surface-modified layer formed on, before forming the paint layer.

The metal layer may be formed by applying at least one metal selected from the group consisting of copper (Cu), aluminum (Al), silver (Ag), gold (Au), nickel (Ni), platinum (Pt), and tungsten (W) on the surface-modified layer by coating. The metal layer may be formed by a typical metal coating method. The metal coating method may include, but is not limited to, either a deposition coating method or a solution coating method. The method of the present invention may further include the steps of forming a resin layer between the surface-modified layer and the metal layer of the coating layer.

The method may further include, in the step (a), mechanically polishing the surface of the parent material including magnesium or magnesium alloy by at least one method selected from the group consisting of gloss polishing, hair line polishing, and blasting.

Preferably, the present invention may produce a magnesium alloy of which the surface texture has a Si-containing magnesium oxide or magnesium hydroxide layer by dipping a magnesium member with a magnesium oxide or magnesium hydroxide layer into an aqueous solution of TEOS/KOH or TEOS/NaOH and then drying it. Thus, the present invention can produce a magnesium alloy with a dense surface-modified layer by such a simple method and make the surface treatment of the magnesium alloy practicable in an aqueous solution without using an organic solvent, thereby avoiding occurrence of the waste organic solvent.

FIG. 3 is a schematic diagram showing a method for preparing a magnesium alloy that involves the surface treatment of the magnesium alloy according to one embodiment of the present invention. FIG. 3 shows an illustrative example that a paint layer is formed on the surface-modified layer.

As illustrated in FIG. 3, the present invention involves mechanically polishing the surface of a parent material including magnesium or magnesium alloy and then carrying out a surface treatment on the magnesium alloy through pre-treatment using a tetralkoxysilane-containing alkaline solution and painting. If necessary, the present invention may further include a pre-treatment process 1 of performing a sol-gel coating, prior to the painting process after the pre-treatment.

More specifically, the present invention involves eliminating dust from the surface of the parent material, mechanically polishing the surface of the parent material, and then cleaning the parent material with an alkaline solution having a specific composition.

In the method of the present invention, the parent material including magnesium or magnesium alloy in the step (a) further includes a natural oxidized layer on its surface. In other words, the parent material contains magnesium greatly reactive to oxygen in the atmosphere and thus inevitably has a natural oxidized layer on its surface. The natural oxidized layer may include at least one selected from the group consisting of magnesium oxide and magnesium hydroxide. The magnesium hydroxide can be produced when the magnesium oxide reacts with the water used in the buffing process or the water in the atmosphere.

In the present invention, the parent material including magnesium or magnesium alloy may further include a metal oxidized layer formed from a separate metal oxide by electron beam vacuum deposition, sputtering deposition, or chemical vapor deposition.

In the present invention, the method of mechanically polishing the surface of the parent material may include, if not specifically limited to, a typical wet or dry mechanical polishing method. For example, the present invention involves mechanically polishing the surface of the parent material, in the step (a), by at least one method selected from the group consisting of gloss polishing, hair line polishing, and blasting.

Generally, the cleaning methods for metal alloys may include a variety of physical or chemical cleaning methods. For example, the physical or chemical cleaning methods include solvent cleaning process, alkali cleaning process, surface active agent cleaning process, electrolytic cleaning process, ultrasonic cleaning process, and so forth. Among these methods, the present invention adopts the alkaline cleaning process using an alkaline solution to clean the surface of a magnesium alloy.

Particularly, the specific alkaline solution used in the present invention uses an aqueous solution containing 1 to 5 wt. % of potassium hydroxide or 1 to 10 wt. % of sodium hydroxide, and 1 to 5 wt. % of tetraethyl orthosilicate. The content of potassium hydroxide less than 1 wt. % results in poor corrosion resistance in the salt spray test, and the content of potassium hydroxide greater than 5 wt. % leads to poor adhesion. The content of sodium hydroxide less than 1 wt. % ends up with poor corrosion resistance in the salt spray test, and the content of sodium hydroxide greater than 10 wt. % causes poor adhesion.

Further, the content of tetraethyl orthosilicate less than 1 wt. % deteriorates the adhesion, and the content of tetraethyl orthosilicate greater than 5 wt. % render tetraethyl orthosilicate insoluble to distilled water.

In the present invention, the surface treatment method may further include cleaning and drying the surface of the magnesium having the surface-modified layer after the alkali treatment process. For example, the present invention may involve sufficiently cleaning the magnesium alloy treated with alkali, washing it for the subsequent process, and then drying it in an oven at 120 to 150° C. for 5 to 10 minutes. If necessary, the method of the present invention may further include separately etching the surface of the cleaned magnesium alloy after completion of the alkali treatment process.

Further, the present invention can provide a magnesium alloy available for the use purpose as an automobile steel sheet or a printed circuit board by forming a coating layer on the surface of the magnesium alloy in the step (c). The coating layer may include a paint layer or a metal layer.

Ultimately, forming a paint layer can secure corrosion resistance. In the case of carrying out the paining process in step (c), there is preferably formed at least one of the paint layer on the surface of the magnesium alloy layer having the surface-modified layer cleaned. The paint layer may be formed by using a typical paint well known in the related art, and the painting method is not specifically limited. Further, the thickness of the paint layer is not specifically limited, but it may be controlled appropriately. For example, the paint used to form the paint layer may include 10 to 60 wt. % of acryl resin having a phosphate group, 5 to 10 wt. % of melamine resin, 5 to 10 wt. % of blocked isocyanate resin, and a remaining content of an organic solvent, a pigment, a dye, a leveling agent, and a silane-based adhesion promoter. The blocked isocyanate may be selected from the group consisting of 1,6-hexamethylene diisocyanate, isophorone diisocyanate (IPDI), and 4,4-bis-isocyanato-cyclohexyl methane. The pigment may be selected from the group consisting of organic pigments, inorganic pigments, pearl pigments, and aluminum paste. The dye may be a metal complex dye.

For the sake of improving the corrosion resistance, the method of the present invention may further include performing a surface treatment process, such as chemical conversion treatment, anodizing treatment, plating, coating, etc., as necessary, prior to the painting process. For example, as illustrated in FIG. 3, the method of the present invention may further include forming a sok gel coating layer on the surface of the cleaned magnesium alloy between the steps (b) and (c) (Pre-treatment 1). The sol-gel coating layer may be formed by using a coating solution well known in the related art, which coating solution is not specifically limited. For a preferred example, the sol-gel solution may include an aqueous solution of silica sol containing alkylalkoxysilane under hydrolysis and condensation polymerization.

Further, when the metal layer is formed, the magnesium alloy is available for the use purpose as the metal clad laminates for printed circuit board, preferably copper clad laminates.

In this case, the metal layer may be formed by applying at least one metal selected from the group consisting of copper (Cu), aluminum (Al), silver (Ag), gold (Au), nickel (Ni), platinum (Pt), and tungsten (W) on the surface-modified layer by metal coating. Preferably, the metal layer is a copper layer.

The present invention may further include forming a resin layer between the surface-modified layer and the metal layer of the coating layer. The metal layer may have a micrometer-scale thickness.

According to the present invention, the surface texture of a magnesium alloy can be made more dense by performing an alkali treatment process using a specified tetralkoxysilane compound (that is, silicate compound) for surface cleaning in the preparation of the magnesium alloy, only to prevent surface appearance defects possibly occurring during the process, defects in the chemical conversion treatment or plating process, or defects in coating adhesion after the painting process or salt water resistance and ensure excellent durability. Particularly, the present invention can secure adhesion stability for the surface-modified layer of the magnesium alloy to enhance mechanical properties. Accordingly, the magnesium alloy of the present invention is available for the use purpose in automobile steel sheets or copper clad laminates for printed circuit board.

### DESCRIPTION OF THE DRAWINGS

FIG. 1 is a schematic diagram showing the cross section of a general magnesium alloy after a surface treatment process.

FIG. 2 is a schematic diagram showing the cross section of a magnesium alloy with dense surface texture according to the present invention.

FIG. 3 is a schematic diagram showing the process of preparing a magnesium alloy that involves surface treatment according to the present invention.

FIGS. 4a and 4b are TEM images showing the cross section of a magnesium alloy according to Example 1 of the present invention.

FIG. 5 shows the degree of Si penetration from TEOS into the surface-treated magnesium alloys of Examples 1 and 2.

FIG. 6 is an electron microscopic image showing the results of a salt spray test with an elapse of time on the magnesium alloy surface-treated after an alkaline surface cleaning according to the method of the present invention.

FIG. 7 shows the results of a coating adhesion test on the magnesium alloys of Examples 1 and 2 of the present invention and Comparative Example 2 after a hot water resistance testing.

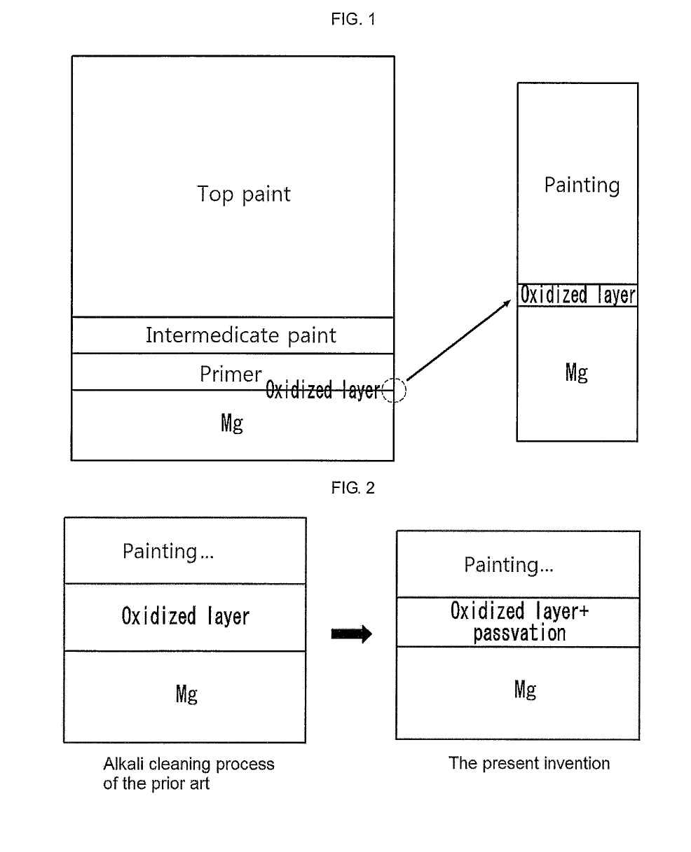

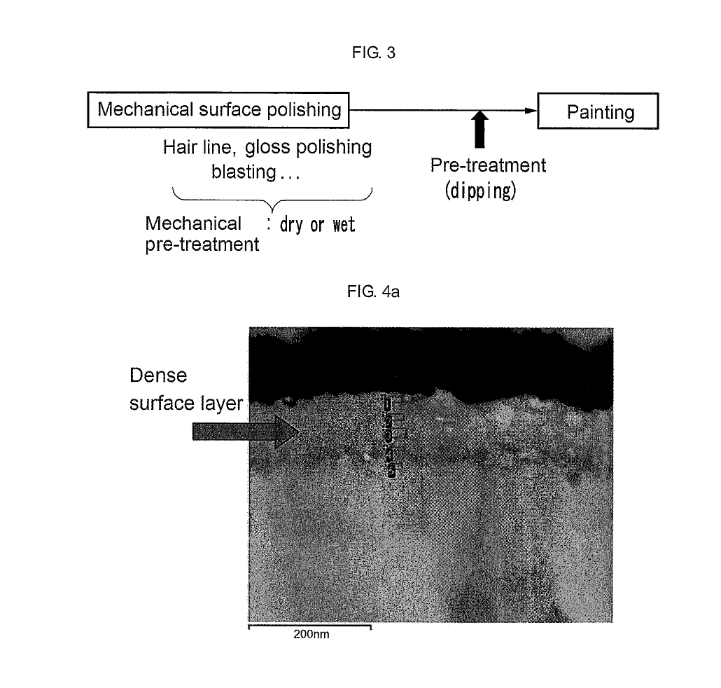

### BEST MODE

Hereinafter, the present invention will be described in further detail according to the embodiments as follows. However, these embodiments are provided as a mere illustration and not intended to limit the scope of the invention.

### Examples 1 and 2

A magnesium alloy AZ31 was prepared by molding a plate material into a defined shape and then first removed of the surface contaminants. The surface of the magnesium alloy was polished with a polishing machine (number of polishing 8/23) and then processed by hair line polish with a water-soluble cutting oil.

Thereafter, the magnesium alloy mechanically surface-polished was dipped into an aqueous alkaline solution containing 1 wt. % of KOH and 20 ml/L of TEOS to carry out a surface treatment process. In this regard, the temperature of the aqueous solution was maintained at 30 and 60° C. and was defined as in the Examples 1 and 2 according to the treatment temperature.

Subsequently, the magnesium alloy after completion of the alkaline cleaning process was dried in a drying oven at 150° C. for 10 min.

In addition, a paint (acryl-based baking paint for metal, NOROO Paint & Coating Co., Ltd.) was painted to a thickness of 25 μm on the surface of the magnesium alloy once to prepare a magnesium alloy that is completed the surface treatment.

### Comparative Example 1

The procedures were treated a surface of the magnesium alloy by the same method as Example 1, except that the magnesium alloy was not subjected to the alkaline cleaning process.

### Comparative Example 2

The procedures were treated the surface of the magnesium alloy by the same method as Example 1, except that the magnesium alloy was subjected to the alkaline cleaning process at 60° C. with an aqueous alkaline solution containing 1 wt. % of KOH alone.

### Example 3

The procedures were treated the surface of the magnesium alloy by the same method as Example 1, except that the magnesium alloy was subjected to the alkaline cleaning process at 60° C. with an aqueous alkaline solution of pH 13.5 containing 1 wt. % of NaOH and 25 ml/L of TEOS.

### Comparative Example 3

The procedures were treated the surface of the magnesium alloy by the same method as Example 3, except that the magnesium alloy was subjected to the alkaline cleaning process at 60° C. with an aqueous alkaline solution containing 1 wt. % of NaOH.

### Experimental Example 1

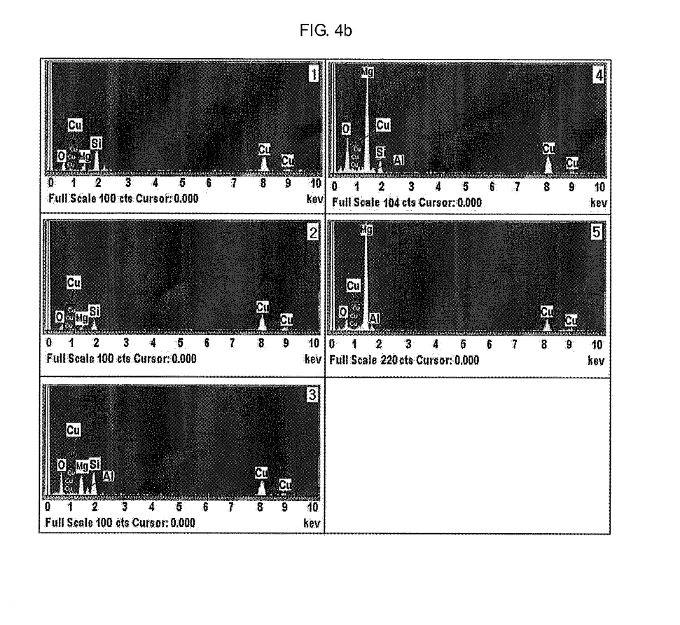

A TEM image was taken of the magnesium alloys AZ31 surface-treated with KOH/TEOS in Examples 1 and 2. The results are presented in FIGS. 4a and 4b, respectively. In this regard, FIG. 4b shows the degree of Si penetration into portions 1 to 5 of the dense surface layer structure of FIG. 4a. As can be seen from FIGS. 4a and 4b, the present invention had a uniform Si distribution in the depth direction of the magnesium alloy.

### Experimental Example 2

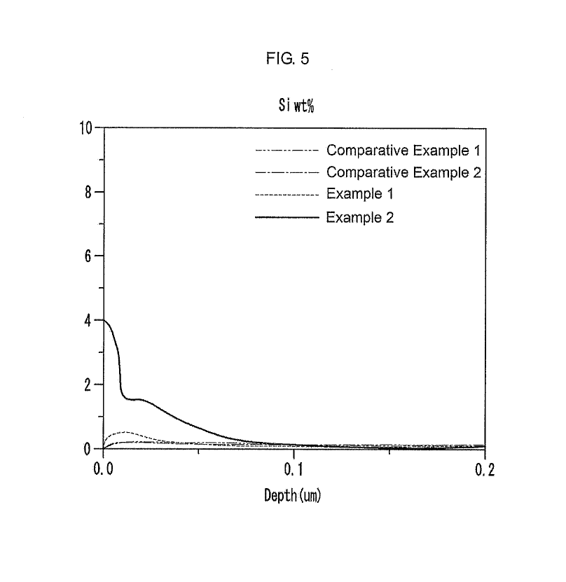

The magnesium alloys AZ31 surface-treated in Examples 1 and 2 were measured in regards to the degree of Si penetration of TEOS. The results are presented in FIG. 5, which also shows the experimental results for the Comparative Examples 1 and 2.

FIG. 5 is results of an observation by using a glow discharge gloss emission spectroscopy (GDOES) on the surface of the magnesium after the surface treatment. The Examples 1 and 2 of the present invention using TEOS in the alkaline cleaning process had a relatively good Si penetration in the depth direction into the surface texture, compared to the Comparative Examples 1 and 2.

### Experimental Example 3

In order to perform a test for reinforcing an oxidized layer, the respective magnesium alloys surface-treated in Examples 1 and 2 and Comparative Example 1 were subjected to the salt spray test (SST) for 96 hours as follows.

A salt water was sprayed on the respective magnesium alloy plate materials of the Examples 1 and 2 and the Comparative Example 1. In 0 hour and 96 hours after the spray, the pictures were taken of the surface of the magnesium alloys to confirm the degree of corrosion.

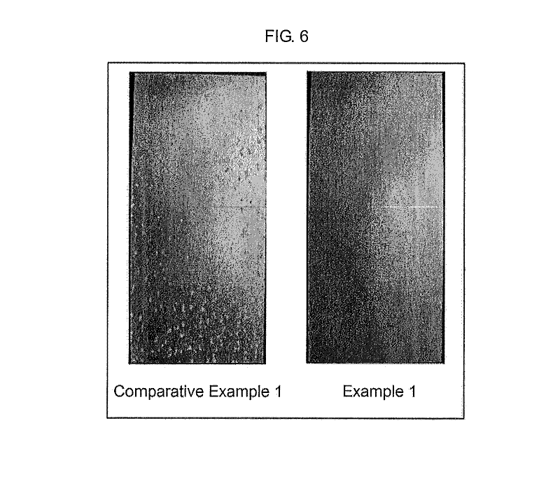

Subsequently, the electron microscopic images were taken of the face part of the surface of the magnesium alloys. The results are presented in FIG. 6. Referring to FIG. 6, no defect was found on the magnesium surface of the Examples 1 and 2 of the present invention, as the magnesium surface is dense due to a use of TEOS in combination with KOH in the alkaline cleaning process. Contrarily, the Comparative Example 1 had corrosion on the magnesium surface as the painting process was performed without an alkaline treatment process.

### Experimental Example 4

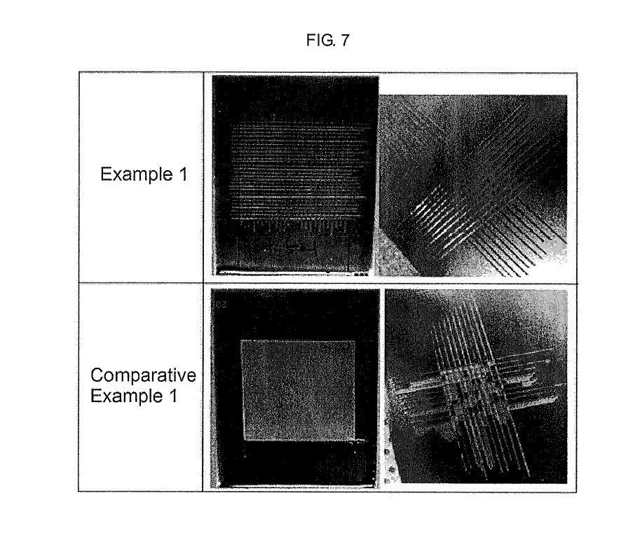

The respective magnesium alloys surface-treated in Examples 1 and 2 and Comparative Example 2 were subjected to a hot water resistance test (100° C., 30 min) and then a coating film adhesion test by a conventional method. The results are presented in FIG. 7. Referring to FIG. 7, the Example 1 of the present invention showed excellent coating film adhesion as the painting process was carried out after the surface treatment process with a silicate-containing alkaline solution. In addition, the Example 2 showed the same results.

Contrarily, the Comparative Example 2 had poor coating film adhesion, as it included the painting process after cleaning with a general alkaline solution alone.

As can be seen from the experimental results, the present invention can prevent appearance defects possibly occurring during the surface treatment of the magnesium alloy, defects caused in the chemical conversion treatment or plating process, or defects in the coating adhesion after the painting process and the salt water resistance. Further, the present invention makes the hydroxide coating layer on the magnesium surface more dense to ensure adhesion and durability of the subsequent surface-treated layer. Accordingly, the magnesium alloys as prepared by the method of the present invention can be used for the automobile steel sheet or the copper clad laminate for printed circuit board to provide products with enhanced mechanical properties.

What is claimed is:

1. A magnesium alloy comprising:
a parent material comprising magnesium or magnesium alloy;
a surface-modified layer being formed on the surface of the parent material and containing Si; and
a coating layer formed on the surface-modified layer,
wherein the surface-modified layer comprises a “—Si—O—Mg—” structure.

2. The magnesium alloy of claim 1, wherein the surface-modified layer comprises a “—Si—O—Mg—O—Si” structure and has a thickness of 50 nm to 150 nm.

3. The magnesium alloy of claim 1, wherein the surface-modified layer is formed by treating the surface of the parent material with an aqueous alkaline solution comprising 1 to 5 wt. % of potassium hydroxide or 1 to 10 wt. % of sodium hydroxide, and 1 to 5 wt. % of tetraethyl orthosilicate.

4. The magnesium alloy of claim 1, wherein the coating layer comprises a paint layer or a metal layer.

5. The magnesium alloy as claimed in claim 4, wherein the paint layer is formed by at least one layer using a paint.

6. The magnesium alloy of claim 4, wherein the metal layer comprises at least one selected from the group consisting of copper (Cu), aluminum (Al), silver (Ag), gold (Au), nickel (Ni), platinum (Pt), and tungsten (W).

7. The magnesium alloy of claim 4, further comprising:
a resin layer for adhering a coating layer on the surface-modified layer between the surface-modified layer and the metal layer of the coating layer.

8. The magnesium alloy of claim 1, wherein the parent material has a surface thereof mechanically polished.

9. The magnesium alloy of claim 1, which is used as an automobile steel sheet or a copper clad laminate for printed circuit board.

10. A surface treatment method for magnesium alloy, comprising the steps of:
(a) providing a parent material comprising magnesium or magnesium alloy;
(b) treating the parent material with a silicate-containing alkaline solution to form a surface-modified layer on the surface of the parent material; and
(c) forming a coating layer on the surface-modified layer,
wherein the alkaline solution uses an aqueous solution containing 1 to 5 wt. % of potassium hydroxide or 1 to 10 wt. % of sodium hydroxide, and 1 to 5 wt. % of tetraethyl orthosilicate.

11. The surface treatment method for magnesium alloy of claim 10, wherein the parent material in the step (a) further comprises a natural oxidized layer comprising magnesium oxide or magnesium hydroxide on the surface thereof.

12. The surface treatment method for magnesium alloy of claim 10, wherein the step (c) of forming a coating layer comprises the steps of forming a paint layer or a metal layer.

13. The surface treatment method for magnesium alloy of claim 12, wherein the paint layer is formed by applying at least one layer of a paint on the surface of the surface-modified layer by coating.

14. The surface treatment method for magnesium alloy of claim 13, further comprising the steps of:
forming a sol-gel coating layer on the surface of the parent material having the surface-modified layer formed thereon, before forming the paint layer.

15. The surface treatment method for magnesium alloy of claim 12, wherein the metal layer is formed by applying at least one metal selected from the group consisting of copper (Cu), aluminum (Al), silver (Ag), gold (Au), nickel (Ni), platinum (Pt), and tungsten (W) on the surface-modified layer by coating.

16. The surface treatment method for magnesium alloy of claim 12, further comprising the steps of:
forming a resin layer between the surface-modified layer and the metal layer of the coating layer.

17. The surface treatment method for magnesium alloy of claim 10, further comprising the steps of:
in the step (a), mechanically polishing the surface of the parent material comprising magnesium or magnesium alloy by at least one method selected from the group consisting of gloss polishing, hair line polishing, and blasting.
